(19) United States
(12) Patent Application Publication
(10) Pub. No.: US 2013/0292038 A1
(43) Pub. Date: Nov. 7, 2013

(54) Method for Vacuum Acquisition during Manufacturing of Vacuum Glass Component

(71) Applicants: Yanbing Li, Henan (CN); Zhangsheng Wang, Henan (CN)

(72) Inventors: Yanbing Li, Henan (CN); Zhangsheng Wang, Henan (CN)

(73) Assignee: LUOYANG LANDGLASS TECHNOLOGY CO., LTD, HENAN (CN)

(21) Appl. No.: 13/980,893

(22) PCT Filed: Aug. 17, 2011
(86) PCT No.: PCT/CN2011/078516

§ 371 Date: Jul. 22, 2013

(30) Foreign Application Priority Data
Jan. 31, 2011 (CN) 201110034719.3

(51) Int. Cl. C03B 23/24

(52) U.S. Cl. CPC C03B 23/245
USPC 156/109; 65/34

(57) ABSTRACT

Disclosed is a method for vacuum acquisition during the manufacturing of a vacuum glass component, which specifically comprises the following steps: glass sheets (1, 3) constituting the vacuum glass component are placed in a vacuum environment having desired degree of vacuum, wherein all the glass sheets (1, 3) are in the vacuum environment independent of each other prior to assembling and ultimate sealing, thus a vacuum space inside the assembled vacuum glass component has exactly the same degree of vacuum as the vacuum environment. Therefore, the degree of vacuum of the processed vacuum glass component can be guaranteed by only controlling the degree of the vacuum environment, thereby avoiding problems existed-in the prior art, enhancing the processing efficiency of the vacuum glass component and also ensuring the quality of the vacuum glass component.

### TECHNICAL FIELD

The invention relates to a method for vacuum acquisition during the manufacturing of vacuum glass component.

### BACKGROUND ARTS

At present, two main methods for vacuum acquisition during the manufacturing of vacuum glass component are as below: one is characterized in that: anbleeding hole is pre-made on glass sheets, then used for vacuumizing the glass component upon the ending of the circumferential airtight sealing of a vacuum glass component, and finally closed after a predetermined degree of vacuum is reached in order to complete the manufacturing of the vacuum glass component, and such a vacuum glass component is structurally shown in FIG. 1; the other one is characterized in that: glass sheets constituting a vacuum glass component are firstly assembled together and then transferred into a vacuum chamber for being vacuumized, and when the degree of vacuum in the vacuum chamber reaches a predetermined value, sealing of the assembled glass sheets is implemented in the vacuum chamber in order to complete the manufacturing of the vacuum glass component.

With regard to the two vacuum glass component-manufacturing methods described above, a conclusion is drawn that: since the interval between the adjacent assembled glass sheets is relatively small, even just dozens of microns, vacuumizing such narrow spaces not only requires long time, but is also difficult for acquiring higher degree of vacuum.

Invention Contents

With respect to the above problems in the prior art, the invention aims at providing a method for vacuum acquisition during the manufacturing of vacuum glass component, with which the vacuum glass component with desired degree of vacuum can be conveniently and fast processed to further enhance the processing efficiency and the quality of the vacuum glass component.

In order to achieve the above objective, the method for vacuum acquisition during the manufacturing of vacuum glass component according to the invention specifically comprises the step that: assembling and ultimate sealing of glass sheets constituting a vacuum glass component are implemented in a vacuum environment having desired degree of vacuum, wherein all the glass sheets are in the vacuum environment independent of each other prior to assembling, thus a vacuum space inside the assembled vacuum glass component has the degree of vacuum completely same as that of the vacuum environment.

Further, the vacuum glass component is subjected to sealing with low melting point glass powder, wherein the low melting point glass powder is preplaced on the surface of the positions to be sealed of the glass sheets.

Further, the vacuum glass component is subjected to sealing through metal brazing technology, wherein metal layers are preplaced on the surface of the positions to be sealed of the glass sheets prior to sealing, and two metal layers to be airtightly interconnected through metal brazing technology are also pre-provided with metal brazing solders; the metal layers are composed of metal foils which are fixedly welded on the surface of the glass sheets through ultrasonic welding, or composed of metallization layers which are sintered directly on the surface of the glass sheets according to known sintering technology; and the metal brazing solders are preplated on the surface of the metal layers, or composed of brazing solder strips fixed on the metal layers.

Further, the vacuum glass component is subjected to sealing through metal welding technology, wherein metal sealing sheets stretching out of the glass sheets are preplaced on the surface of the positions to be sealed of the glass sheets prior to sealing, the metal sealing sheets, through ultrasonic welding, are fixedly welded on the surface of the glass sheets or on the metallization layers which are sintered on the surface of the glass sheets according to known sintering technology, and two metal sealing sheets to be sealed are air-tightly interconnected through metal welding technology which can be laser welding, electron beam welding, seam welding, electric resistance welding, TIG welding or metal brazing.

According to the method of the invention, assembling of glass sheets is implemented in a vacuum environment and the degree of vacuum around each of the glass sheets, which are arranged at interval prior to assembling, is the same as the degree of vacuum of the entire vacuum environment, therefore, the degree of vacuum of the processed vacuum glass component can be guaranteed by only controlling the degree of vacuum of the vacuum environment, thereby avoiding the problems in the prior art, enhancing the processing efficiency of the vacuum glass component and also ensuring the quality of the vacuum glass component. According to the method of the invention, the vacuum glass component with the degree of vacuum of 1−3×10−2 Pa or higher can be easily manufactured.

### DESCRIPTION OF DRAWINGS

FIG. 1 is a structural schematic diagram of the conventional vacuum glass component;

FIG. 2 is a schematic diagram of the vacuum glass component processed according to the method of the invention;

FIG. 3 is a structural schematic diagram of the vacuum glass component in Embodiment 1;

FIG. 4 is a structural schematic diagram of the vacuum glass component in Embodiment 2;

FIG. 5 is a structural schematic diagram of the vacuum glass component in Embodiment 3;

FIG. 6 is a structural schematic diagram of the vacuum glass component in Embodiment 4;

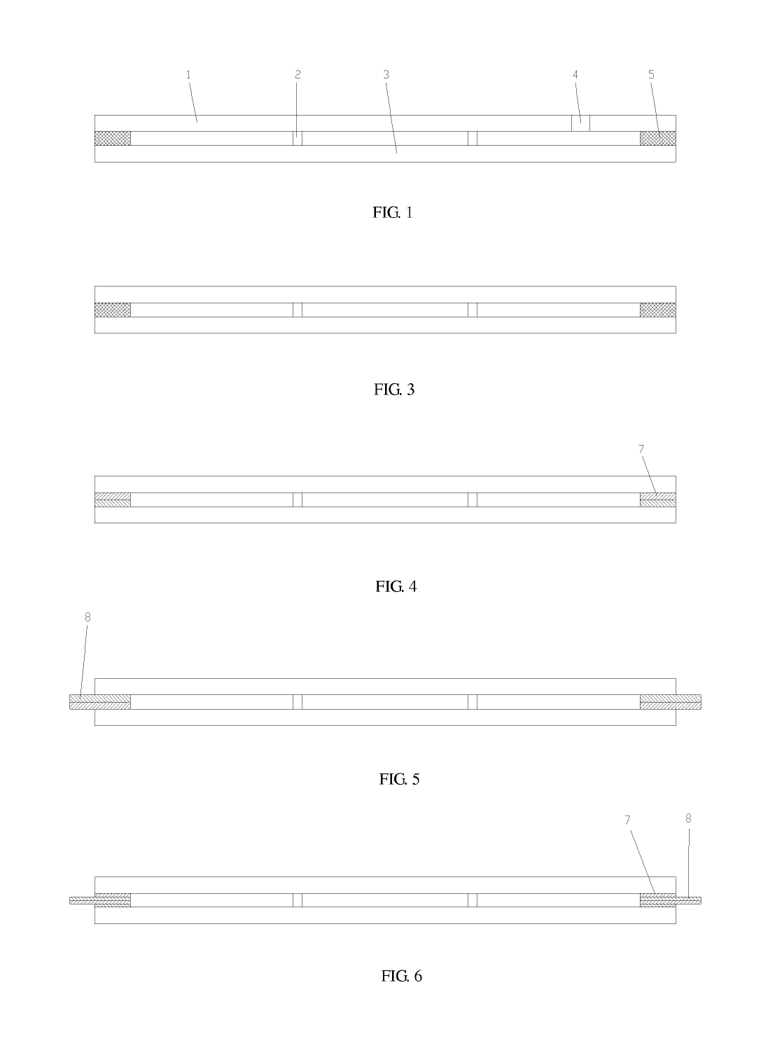

In the drawings, 1 represents upper glass sheet, 2 represents middle supporter, 3 represents lower glass sheet, 4 represents bleeding hole, 5 represents sealing edge, 6 represents vacuum chamber, 7 represents metal layer and 8 represents metal sealing sheet.

### DETAILED DESCRIPTION

Further description of the present invention is made below with the reference to the example of a two-layered vacuum glass component.

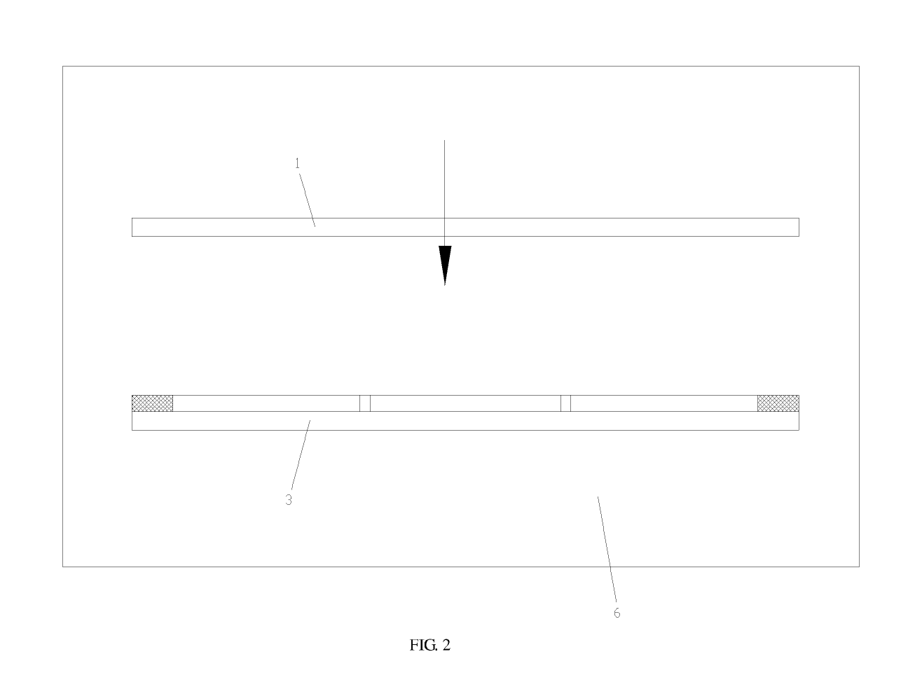

As Shown in FIG. 2, during the processing of a vacuum glass component according to the method of the invention, two glass sheets 1 and 3 constituting the vacuum glass component are firstly placed in a vacuum chamber 6 under the state of being in a vacuum environment independent of each other, i.e. each of the glass sheets has the degree of vacuum completely same as the vacuum environment thereof, in this case, if the degree of vacuum of the vacuum chamber 6 reaches the desired value, the upper glass sheet 1 can be placed above the lower glass sheet 3 along the direction of an arrow shown in the Figure to be further assembled together, if the degree of vacuum of the vacuum chamber 6 does not reach the desired value, it is required to adjust the degree of vacuum of the vacuum chamber to the desired value and then the two glass sheets 1 and 3 are assembled together, afterwards, the assembled vacuum glass component is subjected to sealing through heating or welding or other means to complete the processing of the vacuum glass component.

It is required to be mentioned that, before the two glass sheets 1 and 3 are assembled, middle supporters 2 between the two glass sheets and a sealing material for the circumferential sealing of the glass sheets are preplaced on the surface of the positions to be sealed on the lower glass sheet 3, wherein the sealing material is the known low melting point glass sealing material, therefore, when the two glass sheets 1 and 3 are assembled together, the sealing material 5 and the two glass sheets 1 and 3 can be in melting connection with each other by means of heating in the vacuum chamber, to further complete the airtight sealing of the vacuum glass component.

The degree of vacuum around the upper glass sheet 1 and the lower glass sheet 3 is completely same as that of the vacuum environment thereof prior to assembling, so a vacuum space in the assembled vacuum glass component has the degree of vacuum completely same as that of the vacuum environment, therefore, the degree of vacuum of the vacuum space in the vacuum glass component can be conveniently controlled by controlling the degree of vacuum of the vacuum chamber 6, which not only enhances the processing efficiency of the vacuum glass component, but can also enhances the degree of vacuum and the quality of the vacuum glass component.

What is shown in FIG. 3 is the Embodiment 1 of the vacuum glass component processed according to the method of the invention, and the vacuum glass component uses low melting point glass powder as the sealing material.

What is shown in FIG. 4 is the Embodiment 2 of the vacuum glass component processed according to the method of the invention, the vacuum glass component is subjected to ultimate airtight sealing through metal brazing technology, metal layers 7 have been preplaced and fixed on the surface of the positions to be sealed of the upper and lower glass sheets prior to sealing, and the metal layers of at least one of the two glass sheets are preplated with brazing solders or fixed with brazing solder foil strips, and the metal layers 7 on the two glass sheets can be interconnected in a manner of brazing welding by means of heating after the two glass sheets are assembled together, in order to complete the airtight sealing of the vacuum glass component.

The metal layers 7 can be composed of metal foils, and are fixedly welded on the surface of the glass sheets through ultrasonic welding, or can be composed of metallization layers which are sintered directly on the surface of the glass sheets according to known sintering technology;

What is shown in FIG. 5 is the Embodiment 3 of the vacuum glass component processed according to the method of the invention, the vacuum glass component is subjected to ultimate airtight sealing with metal sealing strips 8, likewise, the metal sealing sheets 8 have been pre-fixed on the surface of the two glass sheets before the two glass sheets 3 and 7 are assembled together, and the metal sealing sheets 8 stretch out of the glass sheets, therefore, the metal sealing sheets 8 on the two glass sheets can be interconnected in a welding manner by means of laser welding, electron beam welding, seam welding, electric resistance welding, TIG welding or metal brazing, in order to complete the airtight sealing of the vacuum glass component. The metal sealing strips 8 are fixedly welded on the surface of the two glass sheets 1 and 3 through ultrasonic welding.

What is shown in FIG. 6 is the Embodiment 4 of the vacuum glass component processed according to the method of the invention, likewise, the vacuum glass component is subjected to ultimate airtight sealing with the metal sealing strips 8, and what is different from the embodiment 3 shown in FIG. 5 is that, the metal sealing strips 8 in the embodiment 4 are fixedly welded, through ultrasonic welding, on the metallization layers 7 which are pre-sintered on the surface of the glass sheets.

The above embodiments are merely for the description of the invention, various embodiments from the skilled in this art understanding the concept of the invention should be within the extent of protection of the invention.

1. A method for vacuum acquisition during the manufacturing of vacuum glass component, characterized in that the method specifically comprises the step that: assembling and ultimate sealing of glass sheets constituting a vacuum glass component are implemented in a vacuum environment having desired degree of vacuum, wherein all the glass sheets are in the vacuum environment independent of each other prior to assembling, thus a vacuum space inside the assembled vacuum glass component has the degree of vacuum completely same as that of the vacuum environment.

2. The method according to claim 1, characterized in that the vacuum glass component is subjected to sealing with low melting point glass powder, wherein the low melting point glass powder is preplaced on the surface of the positions to be sealed of the glass sheets.

3. The method according to claim 1, characterized in that the vacuum glass component is subjected to sealing through metal brazing technology, wherein metal layers are preplaced on the surface of the positions to be sealed of the glass sheets prior to sealing, and two metal layers to be airtightly interconnected through metal brazing technology are also pre-provided with metal brazing solders; the metal layers are composed of metal foils which are fixedly welded on the surface of the glass sheets through ultrasonic welding, or composed of metallization layers which are sintered directly on the surface of the glass sheets according to known sintering technology; and the metal brazing solders are preplated on the surface of the metal layers, or composed of brazing solder strips fixed on the metal layers.

4. The method according to claim 1, characterized in that the vacuum glass component is subjected to sealing through metal welding technology, wherein metal sealing sheets stretching out of the glass sheets are preplaced on the surface of the positions to be sealed of the glass sheets prior to sealing, the metal sealing sheets, through ultrasonic welding, are fixedly welded on the surface of the glass sheets or on the metallization layers which are sintered on the surface of the glass sheets according to known sintering technology, and two metal sealing sheets to be sealed are airtightly interconnected through metal welding technology which can be laser welding, electron beam welding, seam welding, electric resistance welding, TIG welding or metal brazing.
